(19) United States
(12) Patent Application Publication
(10) Pub. No.: US 2023/0022975 A1
(43) Pub. Date: Jan. 26, 2023

(54) INFORMATION PROCESSING DEVICE, DISPLAY DEVICE, INFORMATION PROCESSING METHOD, AND STORAGE MEDIUM

(71) Applicant: JAPAN AEROSPACE EXPLORATION AGENCY, Chofu-shi (JP)

(72) Inventor: Eiichi YOSHIKAWA, Chofu-shi, Tokyo (JP)

(21) Appl. No.: 17/791,716

(22) PCT Filed: Jan. 29, 2021
(86) PCT No.: PCT/JP2021/003245

§ 371 Date: Jul. 8, 2022

(30) Foreign Application Priority Data
Feb. 7, 2020 (JP) 2020-020156

(51) Int. Cl. G01W 1/10

(52) U.S. Cl. CPC G01W 1/10; B64D 45/02

(57) ABSTRACT

According to an embodiment, an information processing device includes an acquirer configured to acquire at least one type of data within meteorological observation data indicating weather at a target location observed at each of a plurality of observation times and meteorological prediction data indicating the weather at the target location predicted using a meteorological prediction model, a deriver configured to derive an index value indicating a threat level of lightning of the target location at each of the plurality of observation times on the basis of the meteorological observation data and the like acquired by the acquirer, and a predictor configured to input the index value derived by the deriver to a model for outputting a future index value when a past or present index value is input and predict a threat of lightning of the target location at a future time later than the observation time on the basis of an output result of the model to which the index value has been input.

### TECHNICAL FIELD

The present invention relates to an information processing device, a display device, an information processing method, and a program.

Priority is claimed on Japanese Patent Application No. 2020-020156, filed Feb. 7, 2020, the content of which is incorporated herein by reference.

### BACKGROUND ART

Several hundred cases of lightning strikes occur annually in aircraft operations in Japan. Although a possibility that a lightning strike on an aircraft will directly lead to a serious accident is extremely low, several hundred million yen in costs are estimated to be incurred annually to repair damage to the outer fuselage of the aircraft and the like. Furthermore, because the inspection or emergency treatment for an aircraft that has been struck by lightning is time-consuming, even small-scale damage often leads to delays in the next flight. Furthermore, large-scale damage can lead to flight cancellations and have a significant impact on flight schedules.

Aircraft operations are broadly divided into a cruise phase and a takeoff/landing phase and individual weather information assistance technologies are used for each phase. As the weather information assistance for lightning in the cruise phase, information using a lightning monitoring system called a lightning detection network system (LIDEN) operated by the Japan Meteorological Agency (JMA) is widely used. Furthermore, the aircraft which is cruising are more likely to take evasive action and lightning strikes during the cruise phase are infrequent. On the other hand, it is estimated that more than 90 [%] of all lightning strikes occur during the takeoff/landing phase.

Technologies for quantitatively detecting a threat of lightning in relation to a lightning strike on such an aircraft are known (see, for example, Patent Literature 1 and 2).

### CITATION LIST

### Patent Literature

### [Patent Literature 1]

Japanese Unexamined Patent Application, First Publication No. 2010-241412

### [Patent Literature 2]

Japanese Unexamined Patent Application, First Publication No. 2019-45403

### SUMMARY OF INVENTION

### Technical Problem

However, it is difficult to predict a future threat of lightning capable of striking an aircraft in conventional technologies.

The present invention has been made in consideration of such circumstances and an objective of the present invention is to provide an information processing device, a display device, an information processing method, and a program capable of predicting a future threat of lightning.

### Solution to Problem

According to an aspect of the present invention, there is provided an information processing device including: an acquirer configured to acquire at least one type of data within meteorological observation data indicating weather at a target location observed at each of a plurality of observation times and meteorological prediction data indicating the weather at the target location predicted using a meteorological prediction model; a deriver configured to derive an index value indicating a threat level of lightning of the target location at each of the plurality of observation times on the basis of at least one type of data within the meteorological observation data and the meteorological prediction data acquired by the acquirer; and a predictor configured to input the index value derived by the deriver to a model for outputting a future index value when a past or present index value is input and predict a threat of lightning of the target location at a future time later than the observation time on the basis of an output result of the model to which the index value has been input.

### Advantageous Effects of Invention

According to an aspect of the present invention, it is possible to predict a future threat of lightning.

### BRIEF DESCRIPTION OF DRAWINGS

FIG. 1 is a diagram showing an example of a configuration of an information processing system according to an embodiment.

FIG. 2 is a diagram showing an example of a configuration of an information processing device according to the embodiment.

FIG. 3 is a flowchart showing an example of a flow of a series of processing steps of the information processing device according to the embodiment.

FIG. 4 is a diagram showing an example of threat level data.

FIG. 5 is an example of a prediction model.

FIG. 6 is a diagram showing an example of a screen that displays a threat level at each time of times t1 to t3 without displaying a result of predicting a future threat level.

FIG. 7 is a diagram showing an example of a screen that displays a threat level at each time of times t1 to t3 without displaying a result of predicting a future threat level.

FIG. 8 is a diagram showing an example of a screen that displays a threat level at each time of times t1 to t3 without displaying a result of predicting a future threat level.

FIG. 9 is a diagram showing an example of a screen that displays a result of predicting a future threat level.

FIG. 10 is an example of an adjustment model.

FIG. 11 is a diagram for schematically describing a prediction model update method.

FIG. 12 is a diagram for schematically describing a prediction model update method.

FIG. 13 is a diagram for schematically describing a prediction model update method.

FIG. 14 is a diagram showing an example of a map in which there are a plurality of target locations.

### DESCRIPTION OF EMBODIMENTS

Hereinafter, embodiments of an information processing device, a display device, an information processing method, and a program of the present invention will be described with reference to the drawings. In a case where the present application is translated from Japanese to English, as used throughout this disclosure, the singular forms “a,” “an,” and “the” include plural reference unless the context clearly dictates otherwise.

### [Configuration of Information Processing System]

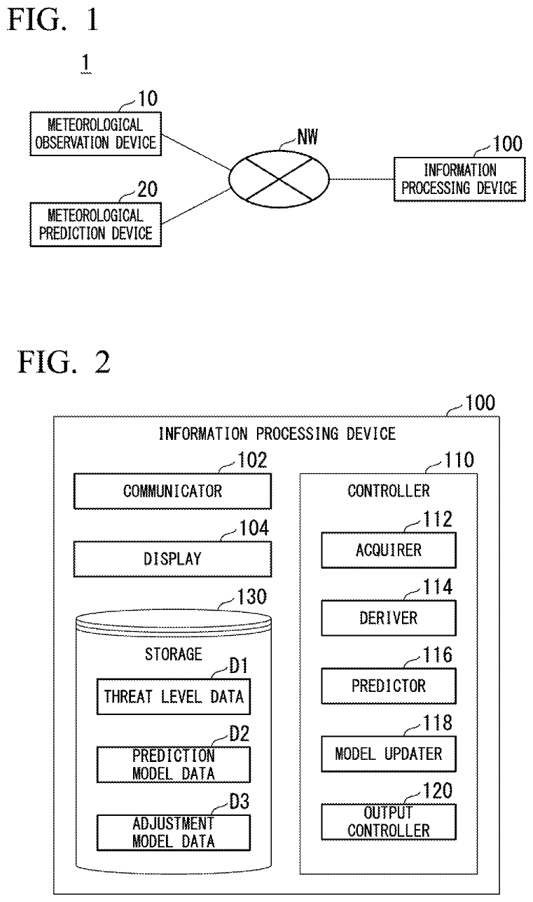

FIG. 1 is a diagram showing an example of a configuration of an information processing system 1 according to the embodiment. As shown in FIG. 1, the information processing system 1 includes, for example, a meteorological observation device 10, a meteorological prediction device 20, and an information processing device 100. These devices are connected to a network NW. The network NW is, for example, a wide area network (WAN) or a local area network (LAN).

The meteorological observation device 10 observes weather at a target location using various sensors such as a meteorological radar and a radiosonde and generates data indicating an observation result (hereinafter referred to as meteorological observation data). Target locations are, for example, airports, areas near the airports, aircraft navigation routes, and areas near the aircraft navigation routes. The meteorological observation device 10 may be installed, for example, within or near a site of an airport where an aircraft takes off and lands, or may be mounted in the aircraft. Meteorological observation data includes physical quantities indicating atmospheric states such as an echo intensity (a precipitation intensity), a Doppler velocity (a wind speed), a wind direction, a temperature, and humidity. When the observation space is divided into a plurality of grid cells (also referred to as mesh cells), the physical quantity may be associated with each of the plurality of grid cells. For example, the grid may be divided into square grid cells at intervals of 5 [km] or 20 [km].

For example, the meteorological prediction device 20 predicts future weather at the target location from the meteorological observation data generated by the meteorological observation device 10 on the basis of the meteorological prediction model (also referred to as a numerical forecasting model) and generates data indicating a prediction result (hereinafter referred to as meteorological prediction data). The meteorological prediction data may include physical quantities whose types are the same as those of physical quantities included in the meteorological observation data such as an echo intensity (a precipitation intensity), a Doppler velocity (a wind speed), a wind direction, a temperature, and humidity. Like the meteorological observation data, the physical quantity in the meteorological prediction data may be associated with each of a plurality of grid cells into which the observation space is divided.

For example, the information processing device 100 may be installed within a site of an airport or may be mounted within an aircraft. The information processing device 100 acquires the meteorological observation data from the meteorological observation device 10 via the network NW and acquires the meteorological prediction data from the meteorological prediction device 20. The information processing device 100 predicts a future threat of lightning that may strike the aircraft on the basis of either one or both of the acquired meteorological observation data and the acquired meteorological prediction data. The information processing device 100 is an example of a “display device.”

### [Configuration of Control Device]

Hereinafter, a configuration of the information processing device 100 will be described. The information processing device 100 may be a single device or a system in which a plurality of devices connected via the network NW operate in cooperation with each other. That is, the information processing device 100 may be implemented by a plurality of computers (processors) included in a system using distributed computing or cloud computing.

FIG. 2 is a diagram showing an example of the configuration of the information processing device 100 according to the embodiment. As shown in FIG. 2, the information processing device 100 includes, for example, a communicator 102, a display 104, a controller 110, and a storage 130. The display 104 is an example of an “outputter.”

The communicator 102 includes, for example, a network interface card (NIC), a wireless communication module including a receiver and a transmitter, and the like. The communicator 102 communicates with the meteorological observation device 10, the meteorological prediction device 20, and other external devices via the network NW.

The display 104 is a user interface that displays various types of information. For example, the display 104 displays an image generated by the controller 110. The display 104 may display a graphical user interface (GUI) for receiving various types of input operations from users (for example, an airport staff member, a pilot, and the like). For example, the display 104 is a liquid crystal display (LCD), an organic electroluminescence (EL) display, or the like.

The controller 110 includes, for example, an acquirer 112, a deriver 114, a predictor 116, a model updater 118, and an output controller 120. The output controller 120 is an example of a “display controller.”

The components of the controller 110 are implemented by, for example, a processor such as a central processing unit (CPU) or a graphics processing unit (GPU) executing a program stored in the storage 130. Some or all of the components of the controller 110 may be implemented by hardware such as a large-scale integration (LSI) circuit, an application-specific integrated circuit (ASIC), or a field-programmable gate array (FPGA) or may be implemented by software and hardware in cooperation.

The storage 130 is implemented by, for example, a hard disc drive (HDD), a flash memory, an electrically erasable programmable read only memory (EEPROM), a read only memory (ROM), a random access memory (RAM), or the like. Various programs such as firmware and application programs are stored in the storage 130. In addition to the program to be referred to by the processor, the storage 130 stores threat level data D1, prediction model data D2, adjustment model data D3, and the like. These various types of data will be described below.

### [Processing Flow of Information Processing Device]

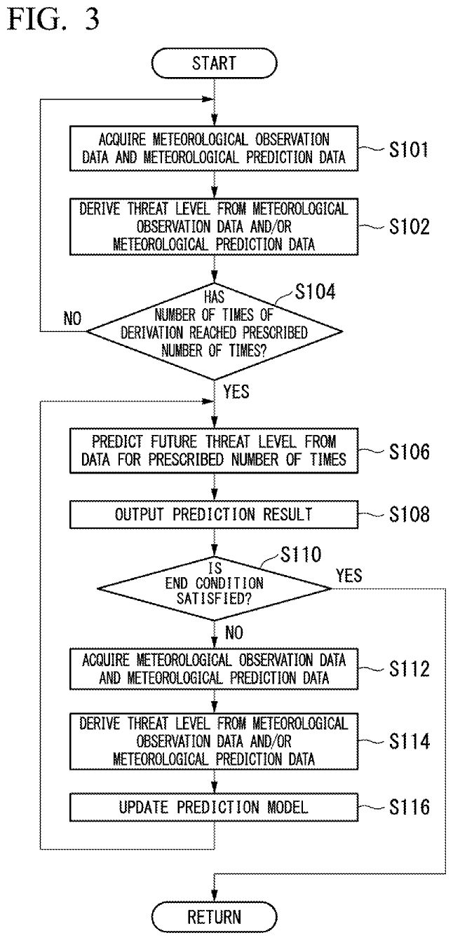

Hereinafter, a flow of a series of processing steps of the information processing device 100 will be described according to a flowchart. FIG. 3 is a flowchart showing an example of a flow of a series of processing steps of the information processing device 100 according to the embodiment. The process of the present flowchart may be iterated, for example, at prescribed intervals. When the information processing device 100 is implemented by a plurality of computers included in a system using distributed computing or cloud computing, the plurality of computers may process a part or all of the process of the present flowchart in parallel.

First, the acquirer 112 acquires meteorological observation data from the meteorological observation device 10 and meteorological prediction data from the meteorological prediction device 20 via the communicator 102 (step S100). The acquirer 112 may acquire only one type of data within the meteorological observation data and the meteorological prediction data.

Subsequently, the deriver 114 derives an index value (hereinafter referred to as a threat level) indicating a threat level of lightning of a target location (near an airport or a navigation route) at an observation time on the basis of one or both types of data within the meteorological observation data and the meteorological prediction data acquired by the acquirer 112 (step S102). The observation time may be a time when the meteorological observation device 10 has observed the weather at the target location or may be a future time when the meteorological prediction device 20 has predicted the weather at the target location from the meteorological observation data.

For example, when the weather at the target location is observed at certain time A, the deriver 114 may derive a threat level of lightning of the target location at time A on the basis of one or both types of data within the meteorological observation data and the meteorological prediction data at time A.

The threat level is, for example, a discrete numerical value such as “small value (0.00 to 0.33)”, “medium value (0.33 to 0.66)”, and “large value (0.66 to 1.00).” The maximum value of the threat level is not limited to 1 and may be any value.

For example, the deriver 114 derives a probability that an aircraft landing at or passing over a target location will be struck by lightning, time loss (for example, operation delay time) or economic loss (for example, the level of damage to the aircraft, the cost of restoration, or the like) caused by the lightning strike as a threat level in the method described in Patent Literature 2. More specifically, the deriver 114 derives the probability of occurrence of a lightning strike, time loss, economic loss, or the like as the threat level of lightning using a certain function f(x). The threat level of lightning may be read as a level of an influence on human economic activities when an aircraft is struck by lightning.

When each physical quantity included in the meteorological observation data and the meteorological prediction data is input as an explanatory variable x, the function f(x) is a function for outputting the threat level of lightning (a probability of occurrence of the lightning strike, time loss, economic loss, or the like) as an objective variable, and may be, for example, a linear function such as f(x)=a1x1+a2x2+ . . . a1 and a2 are weighting coefficients. The function f(x) may include a bias component. The weight coefficient and the bias component may be decided on using a least-squares method on the basis of, for example, the meteorological observation data and meteorological prediction data observed when an aircraft has been actually struck by lightning and the time loss and economic loss caused by the lightning strike. The function f(x) may be implemented by a neural network as described in Patent Literature 2.

As described above, the deriver 114 inputs a multidimensional vector or tensor having each physical quantity as an element included in the meteorological observation data and the meteorological prediction data as an explanatory variable x to the function f(x) and derives a value output by the function f as the threat level of lightning. When the observation space including the target location is divided into a plurality of grid cells, the deriver 114 derives the threat level of lightning of each grid cell from physical quantities associated with the plurality of grid cells. The deriver 114 causes the storage 130 to store the threat level derived for each grid cell as threat level data D1.

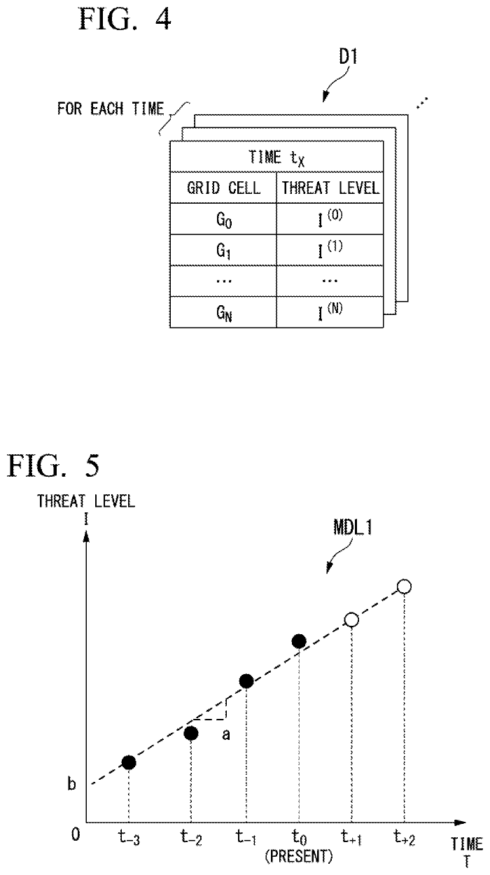

FIG. 4 is a diagram showing an example of threat level data D1. As shown in FIG. 4, the threat level data D1 may be data in which there is a table in which the threat level of lightning is associated with each grid cell for each observation time.

The flowchart of FIG. 3 will be described continuously. Subsequently, the predictor 116 determines whether or not the number of times the threat level of lightning has been derived by the deriver 114 has reached the prescribed number of times (step S104). For example, when the prescribed number of times is 10 and the deriver 114 has already derived the threat level of lightning from meteorological observation data or the like of 10 different observation times, the predictor 116 determines that the number of times the threat level has been derived has reached the prescribed number of times. On the other hand, when the prescribed number of times is 10 and the deriver 114 has not yet derived the threat level of lightning from meteorological observation data of 10 different observation times and the like, the predictor 116 determines that the number of times the threat level has been derived has not reached the prescribed number of times.

When the predictor 116 determines that the number of times the threat level has been derived has not reached the prescribed number of times, the process returns to S100. Thereby, the meteorological observation data and/or the meteorological prediction data at the observation time are sequentially acquired until the number of times the threat level has been derived reaches the prescribed number of times and the threat level of lightning is derived from the meteorological observation data and/or the meteorological prediction data each time.

When the predictor 116 determines that the number of times the threat level has been derived has reached the prescribed number of times, the predictor 116 predicts a threat level of lightning of the target location at a future time from a plurality of threat levels derived for the prescribed number of times (step S106). The future time mentioned here is a time later than any observation time of meteorological observation data or the like acquired for the prescribed number of times to derive the threat level of lightning. For example, when the meteorological observation data and the meteorological prediction data are sequentially acquired at times t₁, t₂, t₃, . . . , t₁₀, the future time may be future time t₁₁ later than time t₁₀, subsequent time t₁₂, or the like.

For example, the predictor 116 predicts the threat level of lightning of a target location at a future time from a plurality of threat levels derived for the prescribed number of times using a prediction model MDL1 defined by the prediction model data D2.

FIG. 5 is an example of the prediction model MDL1. As shown in the illustrated example, the prediction model MDL1 may be an autoregressive model in which the future threat level regresses using past and present threat levels that are time-series data. For example, the autoregressive model can be expressed by Eq. (1).

[Equation. 1]

Iₜ₊₁⁽ⁱ⁾=a⁽ⁱ⁾Iₜ⁽ⁱ⁾+b⁽ⁱ⁾ (1)

In Eq. (1), Iₜ⁽ⁱ⁾ denotes a threat level of certain grid cell i at time t and Iₜ₊₁⁽ⁱ⁾ denotes a threat level of grid cell i after time t+1. a⁽ⁱ⁾ denotes a weighting coefficient of grid cell i and b⁽ⁱ⁾ denotes a bias component of grid cell i.

The autoregressive model for all grid cells can be expressed by Eqs. (2) and (3). Vectors are assumed to be expressed by symbols (→).

[Equation. 2]

Iₜ₊₁=AIₜ+b (2)

[Equation. 3]

Iₜ=[Iₜ⁽⁰⁾,Iₜ⁽¹⁾, . . . ,Iₜ^{(N)}]^{T} (3)

In Eq. (3), N denotes the total number of grid cells. A(→) denotes a matrix that is a set of weighting coefficients a of grid cells G₀ to G_{N}, and b(→) denotes a matrix that is a set of bias components b of grid cells G₀ to G_{N}. For example, the prediction model data D2 may define a polynomial function of an autoregressive model, the matrices A(→) and b(→), which are sets of coefficients of the function, and the like as the prediction model MDL1.

In the example of FIG. 5, the predictor 116 inputs time-series data in which threat levels of past times t₋₃, t₋₂, and t₋₁ and a threat level of current time to are arranged in chronological order to a self-regressive model represented by Eq. (3) or the like. Thereby, the autoregressive model outputs the threat level of lightning of the target location at a future time such as time t₊₁ or t₊₂. The predictor 116 predicts a future threat of lightning at the target location on the basis of the threat level output by the autoregressive model.

The flowchart of FIG. 3 will be described continuously. Subsequently, the output controller 120 causes the display 104 to display information indicating the threat level predicted by the predictor 116 or causes a display of a terminal device (for example, a tablet terminal, a laptop computer, or the like) capable of being used by an airport staff member or a cockpit of an aircraft to display information indicating the threat level predicted by the predictor 116 via the communicator 102 (step S108).

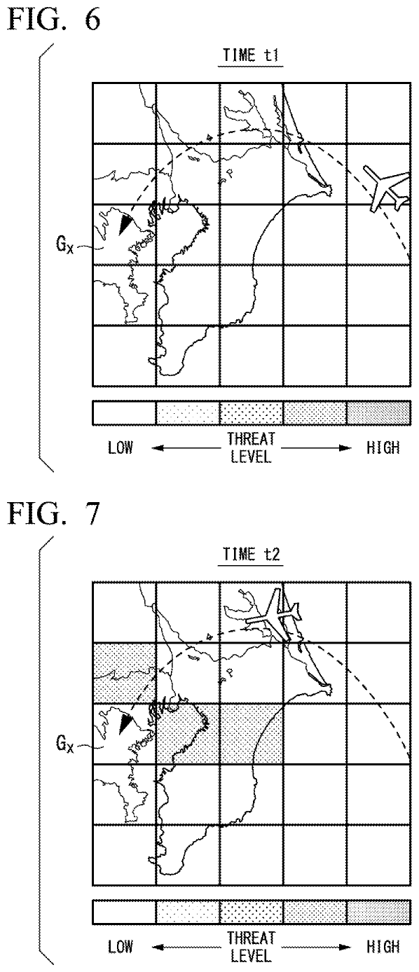

FIGS. 6 to 8 are diagrams showing an example of a screen that displays threat levels at times from time t1 to t3 without displaying a result of predicting a future threat level and FIG. 9 is a diagram showing an example of a screen that displays a result of predicting a threat level. In the screen illustrated in each drawing, the threat level of lightning in each grid cell is replaced with a pixel value such as luminance, saturation, or hue. In the grid cell Gx, there is an airport where the aircraft will land.

The screen illustrated in FIG. 6 shows that a threat level of lightning of any grid cell is low at time t1 when the aircraft is navigating at a position sufficiently distant from the airport (grid cell Gx). When such a screen is displayed, for example, a pilot or an airport controller may determine that the aircraft can land at the airport without deviating from the original navigation route and decide to continue the navigation.

The screen illustrated in FIG. 7 shows that the threat level of lightning around the grid cell Gx where the airport is located is higher than those of other grid cells at time t2 when the aircraft is closer to the airport than at time t1. When such a screen is displayed, for example, the pilot or the airport controller may determine that the risk of the lightning strike is higher than that at time t1 but the aircraft can land at the airport without deviating from the original navigation route and decide to continue the navigation.

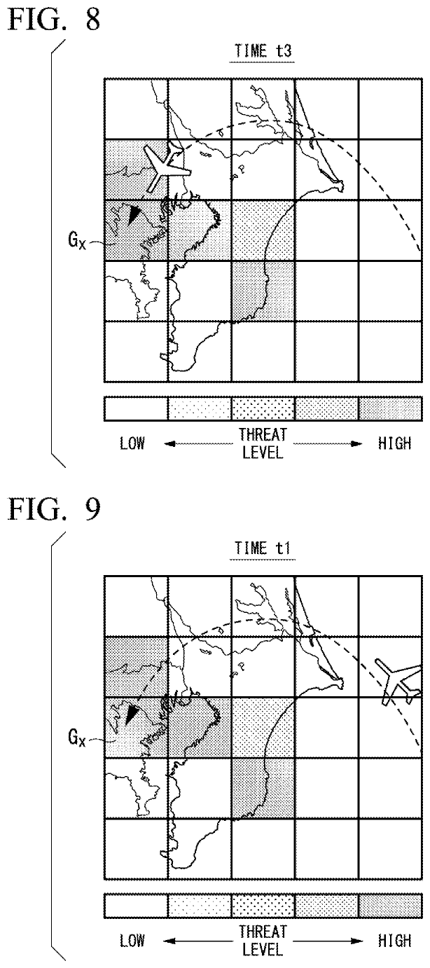

The screen illustrated in FIG. 8 shows that the threat level of lightning around the grid cell Gx where the airport is located at time t3 when the aircraft is in the landing attitude around the airport is higher than that at time t2. When such a screen is displayed, for example, the pilot or the airport controller may decide to allow the aircraft to deviate from the original navigation route and land at another airport or continue flying over the sky until the weather is improved because the risk of the lightning strike is higher than that at time t2. However, according to a situation of a surrounding traffic flow (for example, congestion in the airspace or the like) and a situation (for example, the remaining fuel) of an aircraft, the aircraft may not be able to select an avoidance route and may be forced to land even in a weather environment in which lightning may strike the aircraft.

On the other hand, in the present embodiment, as in the screen illustrated in FIG. 9, for example, at time t1, a screen capable of being displayed at time t3 (a screen of a predicted threat level) is displayed, such that an appropriate navigation route can be selected by giving a sufficient determination grace period to the plot or the airport controller.

The flowchart of FIG. 3 will be described continuously. Subsequently, the output controller 120 determines whether or not an end condition is satisfied (step S110) and the process of the present flowchart ends when it is determined that the end condition is satisfied. End conditions may include, for example, a condition that an airport clerk, a pilot, or the like requests the information processing device 100 to stop the process, a condition that the present time is in a time period (for example, a midnight time period) in which the flight of the aircraft is prohibited, a condition that the aircraft has left an observation space where the information processing device 100 can predict the threat of lightning, and the like.

When the end condition is not satisfied, the acquirer 112 acquires meteorological observation data of the weather observed by the meteorological observation device 10 in the observation corresponding to the time when the threat level of lightning has been predicted by the predictor 116 (hereinafter referred to as a prediction time) and meteorological prediction data of the weather predicted by the meteorological prediction device 20 using the meteorological observation data (step S112).

Subsequently, the deriver 114 derives a threat level of the target location at the prediction time on the basis of one or both types of data within the meteorological observation data and the meteorological prediction data at the prediction time acquired by the acquirer 112 (step S114).

Subsequently, the model updater 118 updates the prediction model MDL1 on the basis of at least one type of data within meteorological observation data and meteorological observation data at the prediction time acquired by the acquirer 112 in the processing of S114 and at least one type of data within meteorological observation data and meteorological observation data at a past observation time earlier than the prediction time acquired by the acquirer 112 in the processing of S100 (step S116). The model updater 118 returns the process to S106 and iteratively updates the prediction model MDL1 until the end condition is satisfied.

For example, the model updater 118 calculates a difference between the threat level predicted by the predictor 116 in the processing of S106 and the threat level derived by the deriver 114 in the processing of S114.

When the calculated difference is greater than or equal to a threshold value (when it can be considered that the prediction of the predictor 116 is wrong), the model updater 118 updates (decides on) a matrix A(→) of a weighting coefficient and a matrix b(→) of a bias component, which are parameters of the prediction model MDL1, using an adjustment model MDL2 defined by the adjustment model data D3. When the prediction model MDL1 is updated, the model updater 118 rewrites the prediction model data D2 of the storage 130 to a data in which the updated prediction model MDL1 is redefined.

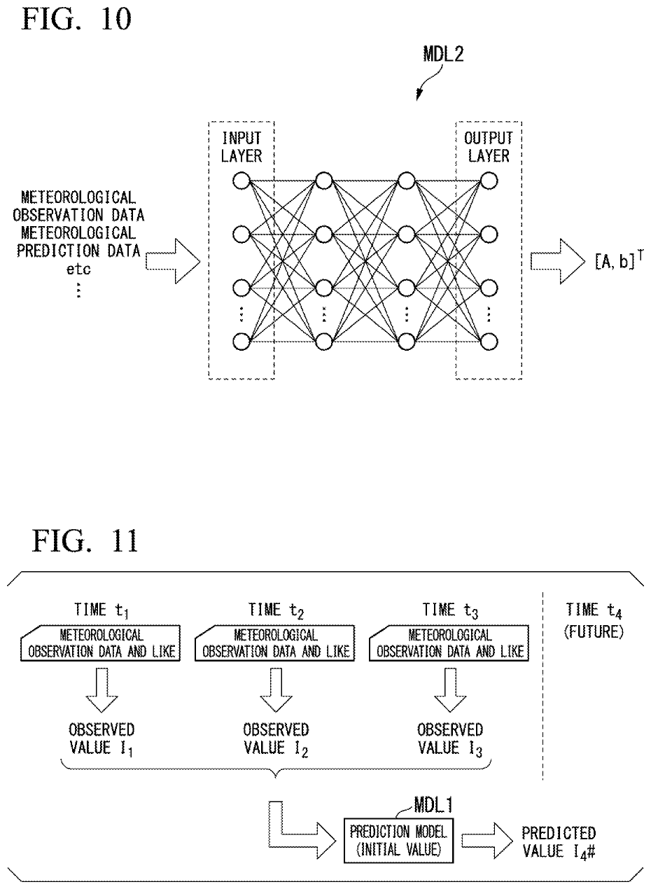

FIG. 10 is an example of the adjustment model MDL2. As shown in the illustrated example, the adjustment model MDL2 is a model trained to output the matrix A(→) and the matrix b(→) of the prediction model MDL1 when a plurality of pieces of meteorological observation data and/or a plurality of pieces of meteorological observation data acquired during a period from a certain observation time in the past to the prediction time (for example, the current observation time) or the like are input.

Such an adjustment model MDL2 may be implemented by, for example, various models such as a neural network, a support vector machine, regularized regression, a random forest, and Gaussian process regression. Hereinafter, as an example, the adjustment model MDL2 will be described as being implemented by a neural network.

When the adjustment model MDL2 is implemented by the neural network, the adjustment model data D3 includes, for example, various types of information such as concatenation information indicating how units included in each of a plurality of layers constituting the neural network are concatenated to each other and a concatenation coefficient assigned to a data input/output between the concatenated units.

The concatenation information includes, for example, information of the number of units included in each layer, information for designating a type of unit to which each unit is concatenated, an activation function of each unit, a gate provided between the units in the hidden layer, and the like. The activation function may be, for example, a rectified linear unit (ReLU) function, a sigmoid function, a step function, another function, or the like. The gate selectively passes or weights data transmitted between the units, for example, in accordance with a value (for example, 1 or 0) returned by the activation function. The concatenation coefficient includes, for example, a weight given to the output data when data is output from a unit of a certain layer to a unit of a deeper layer in a hidden layer of a neural network. Also, the concatenation coefficient may include a bias component peculiar to each layer and the like.

It is assumed that the adjustment model MDL2 is sufficiently trained on the basis of, for example, training data. The training data is a data set in which a correct parameter to be output by the adjustment model MDL2 as a correct label (also referred to as a target) is associated with the input data such as the meteorological observation data and/or the meteorological observation data.

For example, the adjustment model MDL2 may be trained by decreasing the weights of the meteorological observation data and/or the meteorological observation data at the older observation time among the plurality of pieces of meteorological observation data and/or the plurality of pieces of meteorological observation data included as input data in the training data and increasing the weights of the meteorological observation data and/or the meteorological observation data at the newer observation time.

In this way, when the prediction model MDL1 outputs the future threat level and it can be considered that the prediction of the prediction model MDL1 is wrong from the output result, a process of updating the parameters of the prediction model MDL1 using the adjustment model MDL2 that has been sufficiently trained is iterated. Thereby, it is possible to accurately predict the future threat of lightning at the target location while sequentially adapting the prediction model MDL1 to an ever-changing meteorological environment.

FIGS. 11 to 13 are diagrams for schematically describing a method of updating the prediction model MDL1. In FIGS. 11 to 13, an “observed value” represents a threat level derived by the deriver 114 and a “predicted value” represents a threat level predicted by the predictor 116.

In the example of FIG. 11, a threat level I₁ at time t₁ is derived from meteorological observation data and/or meteorological prediction data at time t₁, a threat level I₂ at time t₂ is derived from meteorological observation data and/or the meteorological prediction data at time t₂, and a threat level I₃ at time t₃ is derived from meteorological observation data and/or meteorological prediction data at time t₃. In such a case, three threat levels I₁, I₂, and I₃ are input as time-series data in the prediction model MDL1. When the threat levels I₁, I₂, and I₃ are input, the prediction model MDL1 outputs a threat level I₄ # at future time t₄ later than time t₃. For example, in the case of the initial process, the parameters of the prediction model MDL1 may be initial values.

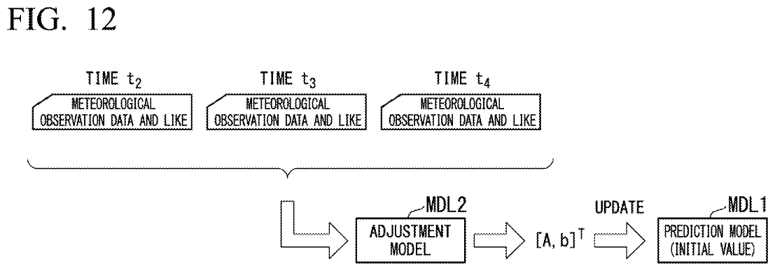

As illustrated in FIG. 12, when a predicted value of the threat level is output by the prediction model MDL1 and the meteorological observation data and the meteorological prediction data at prediction time t4 are further newly acquired, the model updater 118 inputs meteorological observation data and/or meteorological prediction data from time t₂ to time t₄ to the trained adjustment model MDL2. When the meteorological observation data and the meteorological prediction data from time t₂ to time t₄ are input, the adjustment model MDL2 outputs the matrices A(→) and b(→) which are the parameters of the prediction model MDL1. The model updater 118 updates the prediction model MDL1 on the basis of the parameters output by the adjustment model MDL2.

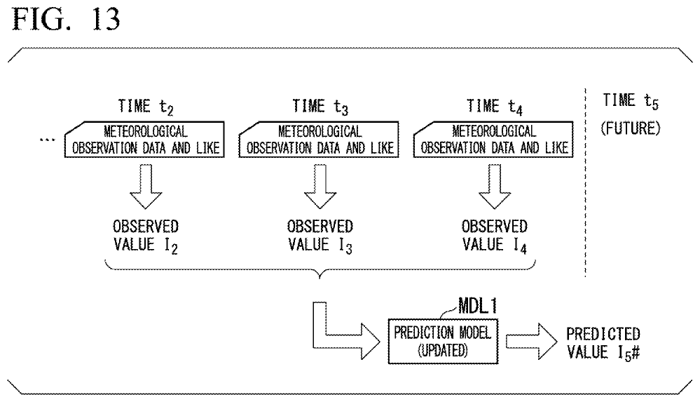

As illustrated in FIG. 13, when meteorological observation data and/or meteorological prediction data at prediction time t₄ are newly acquired, a threat level I₄ at time t₄ is newly derived from the meteorological observation data and/or the meteorological prediction data at time t₄. In addition to the threat levels I₂ and I₃ derived before time t₄, the predictor 116 further inputs the threat level I₄ newly derived at time t₄ as one piece of time-series data to the prediction model MDL1 whose parameters are updated. When the threat levels I₂, I₃, and I₄ are input, the prediction model MDL1 outputs a threat level I₅ # at future time is later than time t₄. In this way, the prediction model MDL1 is updated using the meteorological observation data and/or the meteorological prediction data obtained at the future time while predicting the threat level of lightning at the next future time.

According to the embodiment described above, the information processing device 100 acquires meteorological observation data and meteorological prediction data at a plurality of observation times. The information processing device 100 derives a threat level of lightning of a target location at each of a plurality of observation times on the basis of at least one type of data within the acquired meteorological observation data and meteorological prediction data. When a past or present threat level is input, the information processing device 100 inputs the derived threat level to the prediction model MDL1 that outputs a future threat level, and predicts a threat of lightning of a target location at a future time later than an observation time on the basis of an output result of the prediction model MDL1. Thereby, aircraft pilots and the like can take evasive action on the basis of a result of predicting the threat of lightning and reduce economic loss and time loss due to the lightning strike.

Further, according to the above-described embodiment, the information processing device 100 updates the parameters of the prediction model MDL1 on the basis of at least one type of data within the meteorological observation data and the meteorological prediction data acquired after the time when the threat level of lightning is predicted and therefore it is possible to accurately predict the future threat of lightning at the target location while sequentially adapting the prediction model MDL1 to an ever-changing meteorological environment.

### Modified Examples

Hereinafter, modified examples of the above-described embodiment will be described. For example, when there are a plurality of target locations for which lightning threat prediction is required, the above-described adjustment model MDL2 may be generated for each target location.

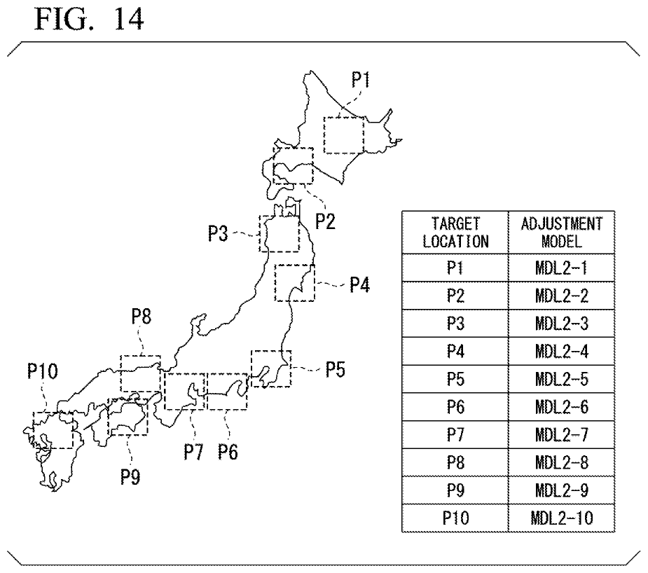

FIG. 14 is a diagram showing an example of a map in which there are a plurality of target locations. In FIG. 14, P denotes a target location (an airport in each region). As shown in FIG. 14, when there are a total of 10 target locations from P1 to P10, an adjustment model MDL2 corresponding to each target location may be generated. For example, an adjustment model MDL2-1 of the target location P1 may be trained on the basis of training data in which a correct parameter is associated with meteorological observation data and/or meteorological prediction data at the target location P1 as a correct label. Likewise, an adjustment model MDL2-2 of the target location P2 may be trained on the basis of the training data in which a correct parameter is associated with meteorological observation data and/or meteorological prediction data at the target location P2 as a correct label. In this way, by providing the adjustment model MDL2 trained according to the weather conditions of each region and switching the adjustment model MDL2 to be used for each target location, a future threat of lightning at the target location can be predicted more accurately.

While modes for carrying out the present invention have been described using embodiments, the present invention is not limited to such embodiments in any way and various modifications and replacements can be added without departing from the scope of the present invention.

### REFERENCE SIGNS LIST

1 Information processing system
10 Meteorological observation device
20 Meteorological prediction device
100 Information processing device
102 Communicator
104 Display
110 Controller
112 Acquirer
114 Deriver
116 Predictor
118 Model updater
120 Output controller
130 Storage

1. An information processing device comprising:
an acquirer configured to acquire at least one type of data within meteorological observation data indicating weather at a target location observed at each of a plurality of observation times and meteorological prediction data indicating the weather at the target location predicted using a meteorological prediction model;
a deriver configured to derive an index value indicating a threat level of lightning of the target location at each of the plurality of observation times on the basis of at least one type of data within the meteorological observation data and the meteorological prediction data acquired by the acquirer; and
a predictor configured to input the index value derived by the deriver to a model for outputting a future index value when a past or present index value is input and predict a threat of lightning of the target location at a future time later than the observation time on the basis of an output result of the model to which the index value has been input.

2. The information processing device according to claim 1, wherein the model is an autoregressive model.

3. The information processing device according to claim 1, further comprising an updater configured to update the model on the basis of the at least one type of data within the meteorological observation data and the meteorological prediction data acquired by the acquirer after a time at which the threat of lightning is predicted by the predictor.

4. The information processing device according to claim 3, wherein, when the at least one type of data within the meteorological observation data and the meteorological prediction data is input, the updater inputs data acquired by the acquirer to a trained model trained to output a parameter of the model and updates the parameter of the model on the basis of the output result of the trained model to which the data has been input.

5. The information processing device according to claim 3,
wherein the predictor iterates a process of predicting the threat of lightning of the target location at the future time using the model updated by the updater, and
wherein the updater iterates a process of updating the model on the basis of the at least one type of data within the meteorological observation data and the meteorological prediction data acquired by the acquirer every time the at least one type of data within the meteorological observation data and the meteorological prediction data is acquired by the acquirer after the time at which the threat of lightning is predicted by the predictor.

6. The information processing device according to claim 1, further comprising:
an outputter configured to output information; and
an output controller configured to cause the outputter to output information indicating the threat of lightning of the target location predicted by the predictor.

7. A display device comprising:
a display configured to display information;
an acquirer configured to acquire at least one type of data within meteorological observation data indicating weather at a target location observed at each of a plurality of observation times and meteorological prediction data indicating the weather at the target location predicted using a meteorological prediction model;
a deriver configured to derive an index value indicating a threat level of lightning of the target location at each of the plurality of observation times on the basis of at least one type of data within the meteorological observation data and the meteorological prediction data acquired by the acquirer;
a predictor configured to input the index value derived by the deriver to a model for outputting a future index value when a past or present index value is input and predict a threat of lightning of the target location at a future time later than the observation time on the basis of an output result of the model to which the index value has been input; and
a display controller configured to cause the display to display information indicating the threat of lightning of the target location predicted by the predictor.

8. An information processing method comprising:
acquiring, by a computer, at least one type of data within meteorological observation data indicating weather at a target location observed at each of a plurality of observation times and meteorological prediction data indicating the weather at the target location predicted using a meteorological prediction model;
deriving, by the computer, an index value indicating a threat level of lightning of the target location at each of the plurality of observation times on the basis of at least one type of data within the meteorological observation data and the meteorological prediction data that have been acquired; and
inputting, by the computer, the derived index value to a model for outputting a future index value when a past or present index value is input and predicting a threat of lightning of the target location at a future time later than the observation time on the basis of an output result of the model to which the index value has been input.

9. A non-transitory computer-readable storage medium storing a program for causing a computer to execute operations, the operations comprising:
acquiring at least one type of data within meteorological observation data indicating weather at a target location observed at each of a plurality of observation times and meteorological prediction data indicating the weather at the target location predicted using a meteorological prediction model;
deriving an index value indicating a threat level of lightning of the target location at each of the plurality of observation times on the basis of at least one type of data within the meteorological observation data and the meteorological prediction data that have been acquired; and
inputting the derived index value to a model for outputting a future index value when a past or present index value is input and predict a threat of lightning of the target location at a future time later than the observation time on the basis of an output result of the model to which the index value has been input.
